(19) United States
(12) Patent Application Publication
(10) Pub. No.: US 2023/0372194 A1
(43) Pub. Date: Nov. 23, 2023

(54) HEATED VIBRATING FOAM ROLLER

(71) Applicant: Sunbeam Products, Inc., Boca Raton, FL (US)

(72) Inventor: Sergiu Mihail Pop, Lake Worth, FL (US)

(21) Appl. No.: 18/321,274

(22) Filed: May 22, 2023

Related U.S. Application Data
(60) Provisional application No. 63/365,077, filed on May 20, 2022.

(51) Int. Cl. A61H 23/02

(52) U.S. Cl. CPC A61H 23/0254; A61H 2201/1215; A61H 2201/0228

(57) ABSTRACT

A vibrating massage and heat therapy roller is provided that features an elongated cylindrical shell within the core of the roller. The rolled houses at least one vibrating motor inside the elongated cylindrical shell and a DC battery that powers the roller, and a low voltage DC battery powered heating wire that wraps evenly around the outside of the roller. An exterior cover may be provided to trap and evenly spread heat. Due to its thermal abilities, the roller may be effective in relieving muscle pains which may be beneficial after or before an exercise or stretching.

### CROSS-REFERENCE TO RELATED APPLICATION

This application claims the benefit of the filing date of U.S. Provisional Application Ser. No. 63/365,077 filed May 20, 2022, entitled, “Heated Vibrating Foam Roller”, which is hereby incorporated by reference as if fully set forth herein.

### FIELD OF THE DISCLOSURE

The disclosure refers to therapeutic foam rollers. More specifically, the disclosure provides a heated and vibrating foam roller.

### BACKGROUND OF THE DISCLOSURE

Foam rollers are commonly used to relieve pressure, tightness, aches, strains, etc. in muscles, joints, and other body parts. Furthermore, some known foam rollers have attempted to increase the therapeutic efficacy by adding heat to standard foam rollers. However, the known solutions for adding heat have several drawbacks.

For example, some solutions employ materials that may be microwaved, but these options do not allow for vibrating massage components to also be utilized because such components are not compatible with microwaves. Additionally, reliance on an external microwave to heat the foam roller limits the heating functionality to locations where the user has access to a microwave. This often will exclude gyms or other locations away from the user's home.

Further still, other heated rollers have used a sleeve that features heating elements, but the heating elements used in such sleeves are subject to damage over a period of use.

In light of these and other deficiencies, there is an ongoing need for an improved foam roller that includes a reliable heating component that may be easily integrated with other therapeutically beneficial features, such as vibrating massage components.

### BRIEF SUMMARY OF THE DISCLOSURE

A first aspect of this disclosure pertains to a foam roller comprising a cylindrical shell configured to house a power supply and a motor therein; a foam cylinder that surrounds the cylindrical shell; the foam cylinder including one or more channels formed thereon with a heating component partially embedded therein in the one or more channels; an exterior cover that encloses the foam cylinder; and a control board electrically coupled to the power supply, the motor, and the heating component, the control board is configured to initiate at least one of a heating mode, a vibration mode, and a dual mode.

A second aspect of this disclosure pertains to the foam roller of the first aspect, wherein the control board is further configured to supply power from the power supply to the heating component when the foam roller is in the heating mode or the dual mode.

A third aspect of this disclosure pertains to the foam roller of the first aspect, wherein the control board is further configured to supply power from the power supply to the motor when the foam roller is in the vibration mode or the dual mode.

A fourth aspect of this disclosure pertains to the foam roller of the first aspect, wherein the control board is further configured to supply power from the power supply to the heating component and the motor when the foam roller is in the dual mode.

A fifth aspect of this disclosure pertains to the foam roller of the first aspect further comprising a top end cap coupled to a first end of the cylindrical shell, wherein the control board is provided beneath the top end cap proximal to the first end of the cylindrical shell.

A sixth aspect of this disclosure pertains to the foam roller of the fifth aspect, wherein the top end cap comprising one of more through holes for receiving one or more user interface elements of the control board.

A seventh aspect of this disclosure pertains to the foam roller of the fifth aspect further comprising a bottom end cap coupled to a second end of the cylindrical shell opposite from the first end.

An eighth aspect of this disclosure pertains to the foam roller of the first aspect further comprising a sleeve that covers at least a portion of the foam cylinder.

A ninth aspect of this disclosure pertains to the foam roller of the first aspect, wherein the power supply is a battery.

A tenth aspect of this disclosure pertains to the foam roller of the first aspect, wherein the heating component comprising a wire and a heating block.

An eleventh aspect of this disclosure pertains to the foam roller of the tenth aspect, wherein the wire is a heating wire.

A twelfth aspect of this disclosure pertains to the foam roller of the first aspect, wherein the cylindrical shell comprising a first second and a second section, wherein when the first section is coupled to the second section, the first section and the second section defined an internal portion of the cylindrical shell therein, and wherein the power supply and the motor are provided within the internal portion of the cylindrical shell.

A thirteenth aspect of this disclosure pertains to the foam roller of the first aspect further comprising a band for securing the exterior cover to the foam cylinder.

A fourteenth aspect of this disclosure pertains to the foam roller of the thirteenth aspect, wherein the band is elastic.

A fifteenth aspect of this disclosure pertains to the foam roller of the first aspect, wherein the control board further comprising a charging receptacle for receiving a connecter to recharge the power supply from an external source.

A sixteenth aspect of this disclosure pertains to A foam roller comprising a cylindrical shell configured to house a power supply and a motor therein; the cylindrical shell comprising a first second and a second section, wherein when the first section is coupled to the second section, the first section and the second section defined an internal portion of the cylindrical shell therein, and wherein the power supply and the motor are provided within the internal portion of the cylindrical shell; a foam cylinder that surrounds the cylindrical shell; the foam cylinder including one or more channels formed thereon with a heating component partially embedded therein in the one or more channels; an exterior cover that encloses the foam cylinder; and a control board electrically coupled to the power supply, the motor, and the heating component, the control board is configured to initiate at least one of a heating mode, a vibration mode, and a dual mode.

A seventeenth aspect of this disclosure pertains to the foam roller of the sixteenth aspect, wherein the control board is further configured to supply power from the power supply to the heating component when the foam roller is in the heating mode; supply power from the power supply to the motor when the foam roller is in the vibration mode; and supply power from the power supply to the heating component and the motor when the foam roller is in the dual mode.

An eighteenth aspect of this disclosure pertains to the foam roller of the sixteenth aspect, wherein the heating component comprising a wire and a heating block.

A nineteenth aspect of this disclosure pertains to the foam roller of the sixteenth aspect further comprising a top end cap coupled to a first end of the cylindrical shell, wherein the control board is provided beneath the top end cap proximal to the first end of the cylindrical shell.

A twentieth aspect of this disclosure pertains to the foam roller of the nineteenth aspect, wherein the top end cap comprising one of more through holes for receiving one or more user interface elements of the control board.

### BRIEF DESCRIPTION OF THE DRAWINGS

For a better understanding of the various embodiments of the present disclosure A foam roller comprising reference may be made to the accompanying drawings in which:

FIG. 1 illustrates an isometric view of a foam roller according to an embodiment;

FIG. 2 illustrates an isometric view of the foam roller of FIG. 1 having an exterior cover removed according to an embodiment;

FIG. 3 illustrates an isometric view of the foam roller of FIG. 2 having the foam material removed to expose an elongated cylindrical shell according to an embodiment;

FIG. 4 illustrates an isometric view of the foam roller of FIG. 3 having a section of the elongated cylindrical shell removed according to an embodiment;

FIG. 5 illustrates an isometric view of a top end cap for the foam roller of FIG. 1 according to an embodiment;

FIG. 6 illustrates an isometric view of a control board for the foam roller of FIG. 1 according to an embodiment;

FIG. 7 illustrates a perspective view of a foam roller according to an embodiment;

FIG. 8 illustrates perspective view of the foam roller of FIG. 7 having an exterior cover removed according to an embodiment;

FIGS. 9-12 illustrate partial perspective views of the foam roller of FIG. 7 having an exterior cover removed according to an embodiment; and

FIG. 13 illustrates a perspective view of a control board for the foam roller of FIG. 7 according to an embodiment.

Before explaining the disclosed embodiment of the present disclosure in detail, it is to be understood that the disclosure is not limited in its application to the details of the particular arrangement shown, since the disclosure is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While this disclosure is susceptible of embodiments in many different forms, there are shown in the drawings and will be described in detail herein specific embodiments with the understanding that the present disclosure is an exemplification of the principles of the disclosure. It is not intended to limit the disclosure to the specific illustrated embodiments. The features of the disclosure disclosed herein in the description, drawings, and claims may be significant, both individually and in any desired combinations, for the operation of the disclosure in its various embodiments. Features from one embodiment may be used in other embodiments of the disclosure.

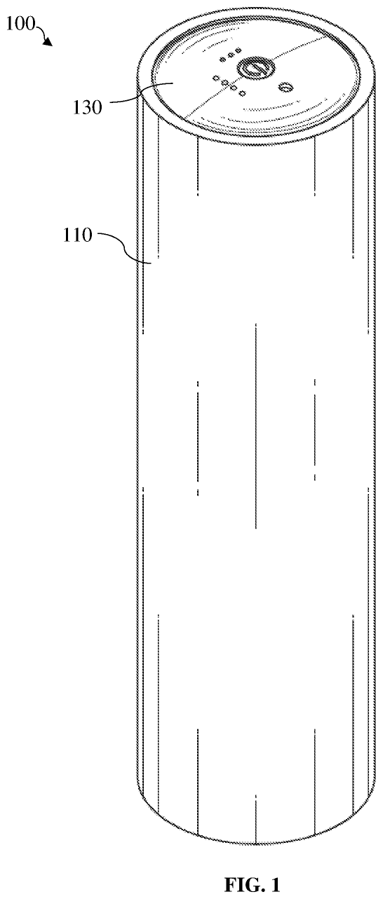

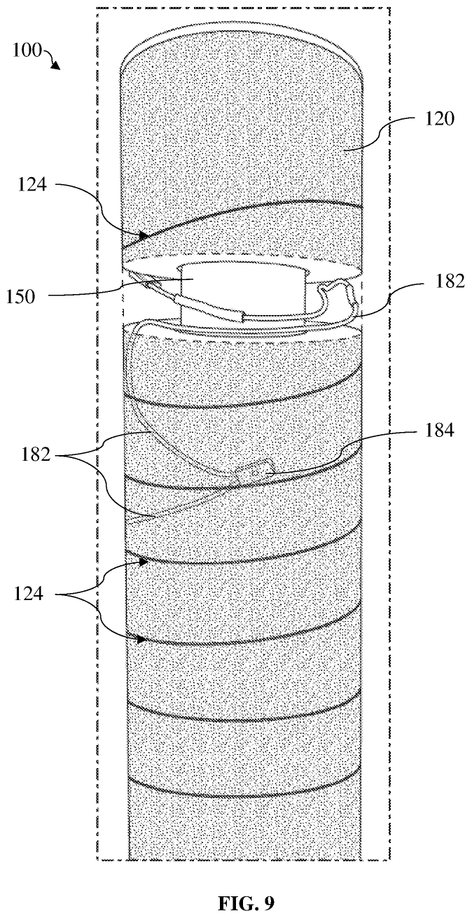

FIG. 1 illustrates an isometric view of a foam roller 100 having heating and vibrating functions according to disclosed embodiments. As illustrated in FIG. 1, the foam roller 100 may include an exterior cover 110 configured to surround various internal components of the foam roller 100. In some embodiments, the exterior cover 110 may be configured to trap and evenly spread heat from one or more heating components 180 (see FIG. 9) of the foam roller 100.

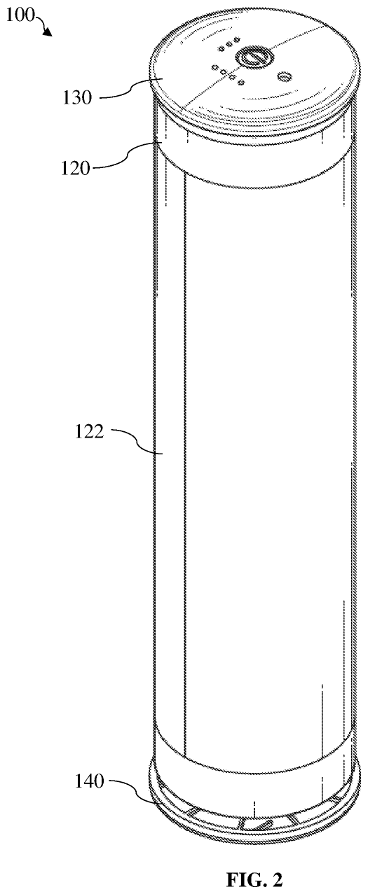

FIG. 2 illustrates an isometric view of the foam roller 100 having the exterior cover 110 removed to better illustrate some of the internal components of the foam roller 100. In particular, the foam roller 100 may include a foam cylinder 120 disposed between a top end cap 130 and a bottom end cap 140. The foam cylinder 120 may be made from a rigid or semi-rigid foam material suitable for use in reliving pressure, tightness, aches, strains, and the like in a user's muscles, joints, and/or other body parts.

The foam roller 100 may also include a sleeve 122 that covers at least a portion of the foam cylinder 120. In some embodiments, the sleeve 122 may be configured to assist in securing one or more heating components 180 within the foam cylinder 120.

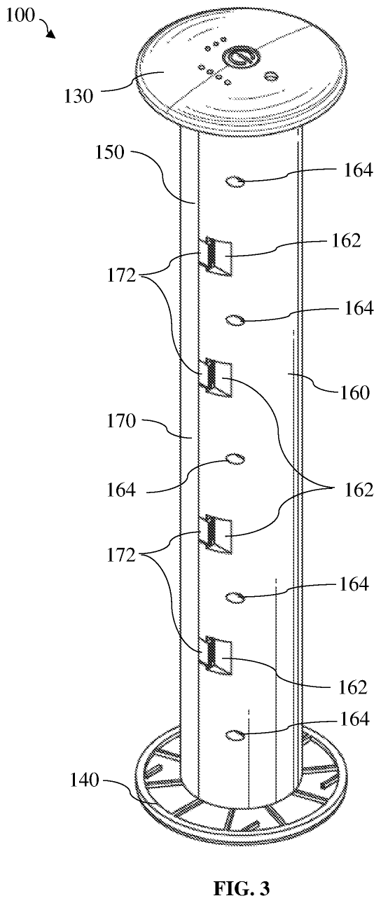

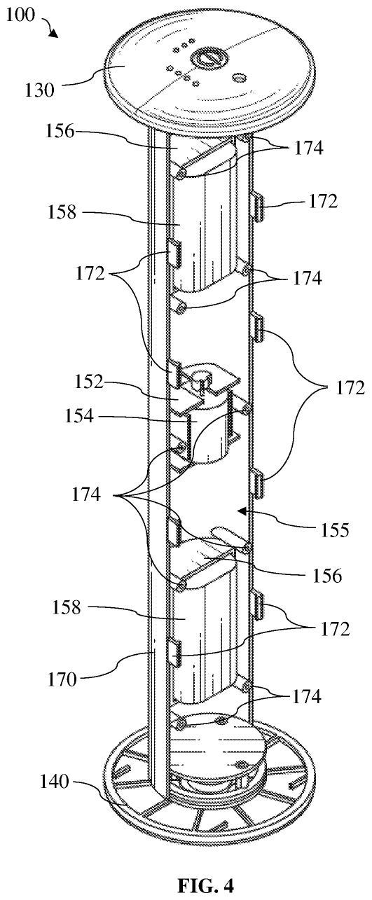

FIG. 3 illustrates an isometric view of the foam roller 100 having the foam cylinder 120 removed to expose internal components of the foam roller 100. In particular, the foam roller 100 may include an elongated cylindrical shell 150 at a core of the foam cylinder 120 and surrounded thereby the foam cylinder 120. The elongated cylindrical shell 150 may be coupled to the top end cap 130 at a first end and the bottom end cap 140 at a second end opposite from the first end. The elongated cylindrical shell 150 may include a first section 160 (as shown in FIG. 3) and a second section 170 (as shown in FIG. 4). The first section 160 and the second section 170 may be coupled together to form the elongated cylindrical shell 150, which may include an interior region 155.

Referring to FIGS. 3 and 4, the second section 170 may include tabs 172 that may fit into slots 162 on the first section 160. The first section 160 may also include fastening holes 164 that may align with fastener receivers 174 on the second section 170. In some embodiments, fasteners may be fed through the fastening holes 164 and be secured within the fastener receivers 174, thus securing the first section 160 with the second section 170 to form the elongated cylindrical shell 150. However, various other types of fastening and securing arrangements are also possible and contemplated herein.

In some embodiments, the elongated cylindrical shell 150 may be made from a plastic polymer material, but other suitable materials known in the art are also contemplated. A motor housing 152 configured to house a vibration motor 154 therein may be provided in the interior region 155 of the elongated cylindrical shell 150. A power supply housing 156 configured to house a power supply 158 therein may also be provided in the interior region 155 of the elongated cylindrical shell 150. In some embodiments, the power supply 158 may be a battery, such as a direct current (DC) battery. As can be appreciated, depending on the implementation, more than one motor housing 152 and more than one vibration motor 154 may be provided. Likewise, more than one power supply housing 156 and more than one power supply 158 may be provided as well. For example, FIG. 4 illustrates an example embodiment including one vibration motor 154 and two power supplies 158. However, other variations are also possible and contemplated herein.

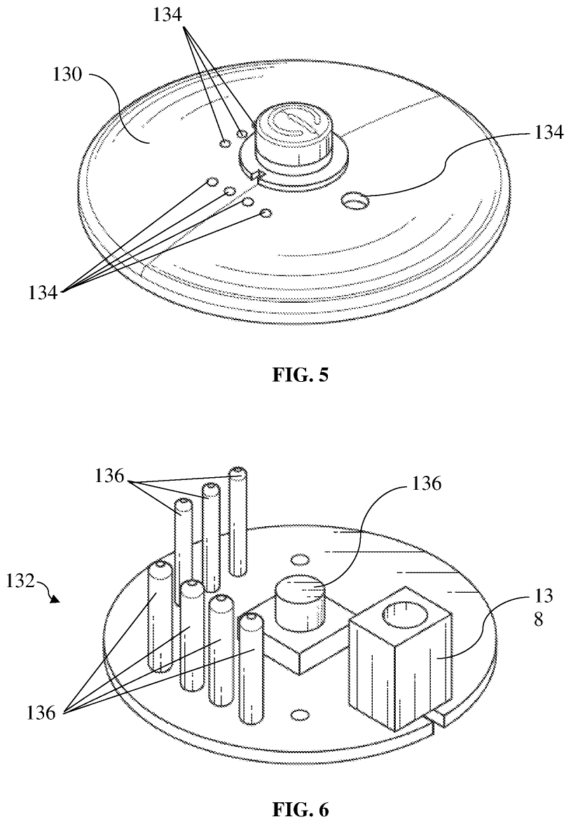

FIG. 5 illustrates an isometric view of the top end cap 130 and FIG. 6 illustrates an isometric view of a control board 132 for the foam roller 100 according to an embodiment. The top end cap 130 may include one or more through holes 134 for receiving one or more user interface elements 136 provided on the control board 132. The user interface elements 136 may include a power button for turning on the electrical components of the foam roller 100 and one or more mode selectors configured to change between several operational modes of the foam roller 100. The user interface elements 136 may further include one or more indicators, which may be visual indicators (such as LEDs, a display, and the like) and/or audio indicators.

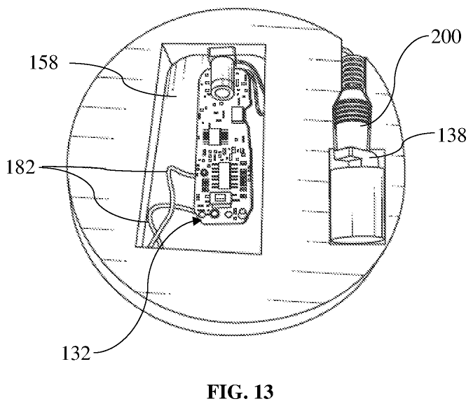

One or more of the through holes 134 of the top end cap 130 may be configured to receive a charging receptacle 138 provided on the control board 132. The charging receptacle 138 may be electrically coupled to the power supply 158 and may be configured to receive a power supply connecter 200 (see FIG. 13) to couple the power supply 158 to an external power supply (not shown) for recharging.

The operational modes of the foam roller 100 may include, for example, a heating mode where the control board 132 activates the heating components 180 of the foam roller 100 to heat the foam roller 100 from a first temperature to a second temperature or to a predetermined temperature. The foam roller 100 may include a temperature sensor configured to monitor a temperature of the foam roller 100. The heating of the foam roller 100 may be performed in a uniform fashion across the foam roller 100.

The operational modes of the foam roller 100 may also include a vibration mode where the control board 132 activates the vibration motor 154 to vibrate the foam roller according to one or more preconfigured vibration patterns. In some embodiments, the control board 132 may activate the vibration motor 154 by coupling the vibration motor 154 to the one or more power supply 158. Further still, in some embodiments, the various operational modes may also include a dual mode where the control board activates both the heating components 180 and the vibration motor 154.

The user interface elements 136 may include a control switch to set and/or change the predetermined temperature and/or the one or more preconfigured vibration patterns. The control board 132 may include a wired or wireless communication interface for connecting to an external user device and for receiving various operating commands therefrom.

In some embodiments, the control board 132 may include a transceiver device and a memory, each of which may be in communication with control circuitry, one or more programmable processors, and executable control software as would be understood by one of ordinary skill in the art. The control software may be stored on a transitory or non-transitory computer readable medium, including, but not limited to local computer memory, RAM, optical storage media, magnetic storage media, flash memory, and the like, and some or all of the control circuitry, the programmable processors, and the control software may execute and control at least some of the methods described herein.

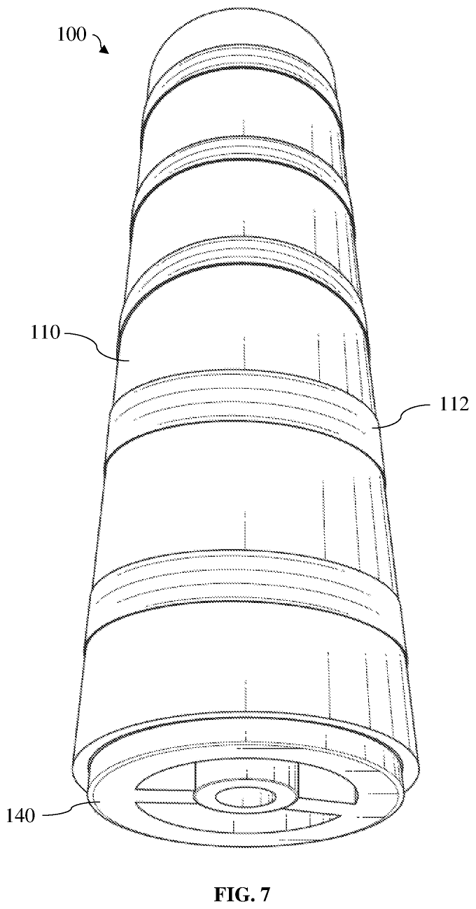

Referring to FIG. 7, the exterior cover 110 may be secured over the foam cylinder 120 through one or more bands 112. In some embodiments, the one or more bands 112 may include an elastic material that at least partially compresses the exterior cover 110 so as to secure the exterior cover 110 over the foam cylinder 120. Alternatively, in some embodiments, the exterior cover 110 may be a one piece molded or welded construction that friction fits over the foam cylinder 120.

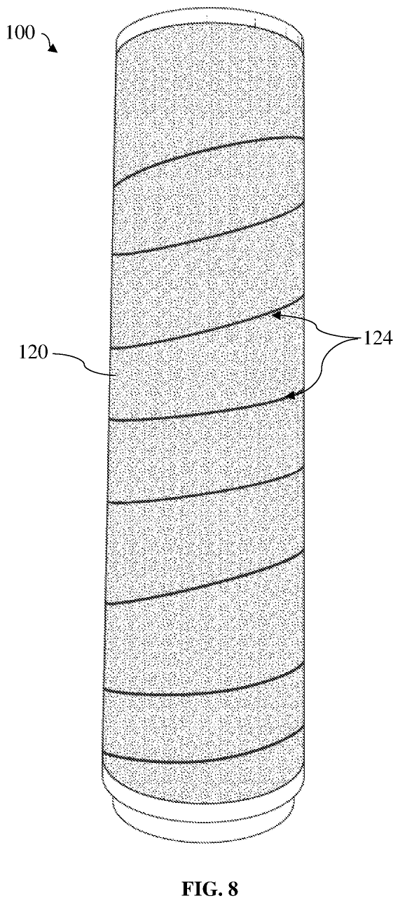

FIG. 8 illustrates the foam cylinder 120 having the one or more channels 124 disposed therein for receiving and securing the heating components 180 of the foam roller 100. In some embodiments, the one or more channels 124 may be laid out in a spiral pattern on an external surface of the foam cylinder 120 to better provide even distribution of the heating components 180. However, other distributions of the one or more channels 124 are also contemplated.

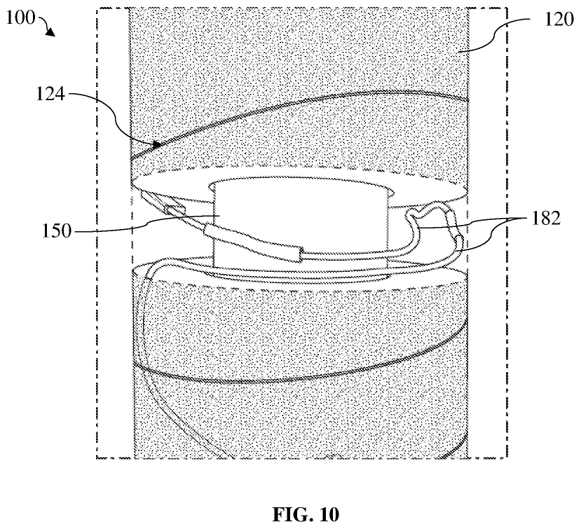

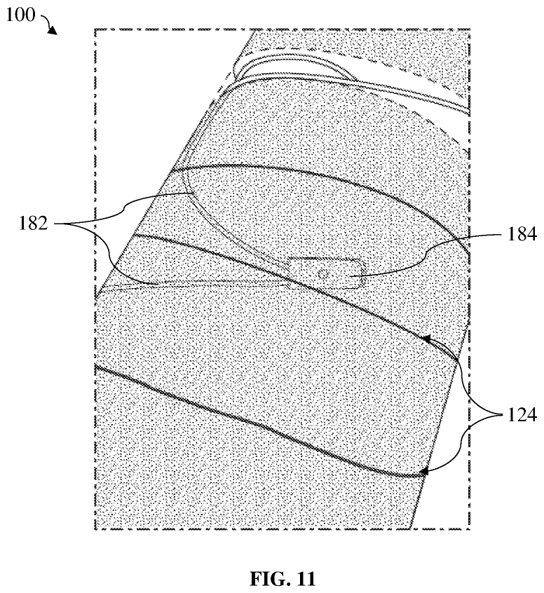

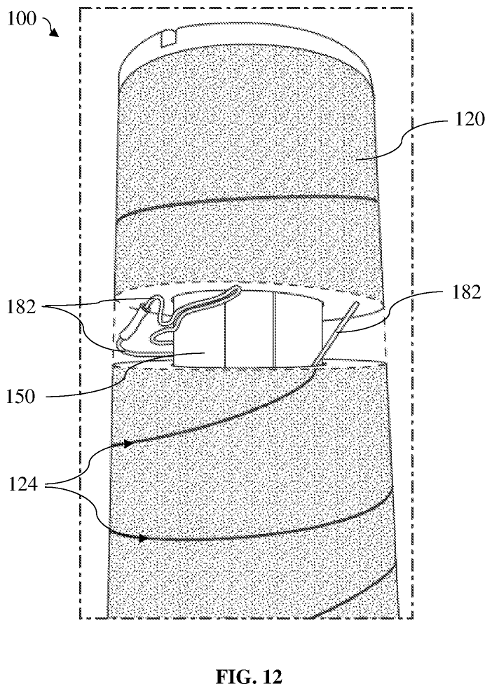

Referring to FIGS. 9-12, the heating components 180 of the foam roller 100 may include wire 182 inset into the one or more channels 124 and coupled to one or more heating blocks 184. In embodiments, the wire 182 may include low voltage heating wire. Additionally or alternatively, the wire 182 may include non-heating wire.

FIG. 13 illustrates the control board 132 according to another embodiment. The control board 132 may be electrically coupled to the wire 182 and the one or more heating blocks 184. In operation, when the control board 132 activates either the heating mode or the dual mode, the control board 132 may supply electrical power from the one or more power supply 158 to the wire 182 and the one or more heating blocks 184. Then, the wire 182 and/or the one or more heating blocks 184 may convert some of the supplied electrical power into heat that is the dissipated throughout the foam cylinder 120 and up through the exterior cover 110.

From the foregoing, it will be seen that the various embodiments of the present disclosure are well adapted to attain all the objectives and advantages hereinabove set forth together with still other advantages which are obvious, and which are inherent to the present structures. It will be understood that certain features and sub-combinations of the present embodiments are of utility and may be employed without reference to other features and sub-combinations. Since many possible embodiments of the present disclosure may be made without departing from the spirit and scope of the present disclosure, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present disclosure.

Specific embodiments of a heated vibrating foam roller according to the present disclosure have been described for the purpose of illustrating the manner in which the disclosure may be made and used. It should be understood that the implementation of other variations and modifications of this disclosure and its different aspects will be apparent to one skilled in the art, and that this disclosure is not limited by the specific embodiments described. Features described in one embodiment may be implemented in other embodiments. The subject disclosure is understood to encompass the present disclosure and any and all modifications, variations, or equivalents that fall within the spirit and scope of the basic underlying principles disclosed and claimed herein.

What is claimed is:

1. A foam roller comprising:
a cylindrical shell configured to house a power supply and a motor therein;
a foam cylinder that surrounds the cylindrical shell; the foam cylinder including one or more channels formed thereon with a heating component partially embedded therein in the one or more channels;
an exterior cover that encloses the foam cylinder; and
a control board electrically coupled to the power supply, the motor, and the heating component, the control board is configured to initiate at least one of a heating mode, a vibration mode, and a dual mode.

2. The foam roller of claim 1, wherein the control board is further configured to supply power from the power supply to the heating component when the foam roller is in the heating mode or the dual mode.

3. The foam roller of claim 1, wherein the control board is further configured to supply power from the power supply to the motor when the foam roller is in the vibration mode or the dual mode.

4. The foam roller of claim 1, wherein the control board is further configured to supply power from the power supply to the heating component and the motor when the foam roller is in the dual mode.

5. The foam roller of claim 1 further comprising:
a top end cap coupled to a first end of the cylindrical shell, wherein the control board is provided beneath the top end cap proximal to the first end of the cylindrical shell.

6. The foam roller of claim 5, wherein the top end cap comprising one of more through holes for receiving one or more user interface elements of the control board.

7. The foam roller of claim 5 further comprising:
a bottom end cap coupled to a second end of the cylindrical shell opposite from the first end.

8. The foam roller of claim 1 further comprising a sleeve that covers at least a portion of the foam cylinder.

9. The foam roller of claim 1, wherein the power supply is a battery.

10. The foam roller of claim 1, wherein the heating component comprising a wire and a heating block.

11. The foam roller of claim 10, wherein the wire is a heating wire.

12. The foam roller of claim 1, wherein the cylindrical shell comprising a first second and a second section,
wherein when the first section is coupled to the second section, the first section and the second section defined an internal portion of the cylindrical shell therein, and
wherein the power supply and the motor are provided within the internal portion of the cylindrical shell.

13. The foam roller of claim 1 further comprising a band for securing the exterior cover to the foam cylinder.

14. The foam roller of claim 13, wherein the band is elastic.

15. The foam roller of claim 1, wherein the control board further comprising a charging receptacle for receiving a connecter to recharge the power supply from an external source.

16. A foam roller comprising:
a cylindrical shell configured to house a power supply and a motor therein; the cylindrical shell comprising a first second and a second section, wherein when the first section is coupled to the second section, the first section and the second section defined an internal portion of the cylindrical shell therein, and wherein the power supply and the motor are provided within the internal portion of the cylindrical shell;
a foam cylinder that surrounds the cylindrical shell; the foam cylinder including one or more channels formed thereon with a heating component partially embedded therein in the one or more channels;
an exterior cover that encloses the foam cylinder; and
a control board electrically coupled to the power supply, the motor, and the heating component, the control board is configured to initiate at least one of a heating mode, a vibration mode, and a dual mode.

17. The foam roller of claim 16, wherein the control board is further configured to:
supply power from the power supply to the heating component when the foam roller is in the heating mode;
supply power from the power supply to the motor when the foam roller is in the vibration mode; and
supply power from the power supply to the heating component and the motor when the foam roller is in the dual mode.

18. The foam roller of claim 16, wherein the heating component comprising a wire and a heating block.

19. The foam roller of claim 16 further comprising:
a top end cap coupled to a first end of the cylindrical shell, wherein the control board is provided beneath the top end cap proximal to the first end of the cylindrical shell.

20. The foam roller of claim 19, wherein the top end cap comprising one of more through holes for receiving one or more user interface elements of the control board.
